(19) United States
(12) Patent Application Publication
(10) Pub. No.: US 2002/0164067 A1
(43) Pub. Date: Nov. 7, 2002

(54) Nearest neighbor edge selection from feature tracking

(75) Inventors: David B. Askey, Carlisle, MA (US); Anthony P. Bertapelli, Milford, MA (US); Curt A. Rawley, Windham, NH (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: SynaPix, Lowell, MA

(21) Appl. No.: 09/847,864

(22) Filed: May 2, 2001

(51) Int. Cl. G06K 9/00

(52) U.S. Cl. 382/154

(57) ABSTRACT

A method for selecting nearest neighbor edges to construct a 3D model from a sequence of 2D images of a scene. The method includes tracking features of the scene among successive images to generate 3D feature points. The entries of the feature point data correspond to the coordinate positions in each image which a true 3D feature point is viewed. The method also generates depth data of the features of the scene, with entries in the data corresponding to the coordinate position of the features in each image along a depth axis. The method then uses the feature track data, original images, depth data, input edge data, and visibility criteria to determine the position of vertices of the 3D model surface. The feature track data, original images, depth data, and input edge data also provide visibility information to guide the connections of the model vertices to construct the edges of the 3D model.

### BACKGROUND OF THE INVENTION

This invention relates generally to reconstruction of a three-dimensional (3D) model of an object or scene from a set of image views of the object or scene. More particularly, this invention uses visibility information to guide the 3D connection of the model vertices.

In image-based modeling, a 3D model is constructed from a set of images of the object or scene to be modeled. The typical process involves:

Acquiring the image data in digital form, possibly with associated range (depth) data.

Aligning depth data from multiple views in 3D to create a single set of 3D feature points of the scene or object in a world coordinate system.

Connecting the 3D feature points with edges to form a 3D mesh that spans the surface of the model.

Filling in the polygon faces or surface patches, with each polygon or surface patch bound by a set of edges determined above.

The depth data from multiple views will generally not align accurately in 3D. In addition, determining a set of mesh edges that properly connects the 3D points is highly sensitive to the positional accuracy of the 3D points. Even for accurately placed 3D points, traditional modeling approaches tend to incorrectly reconstruct connecting edges when using 3D point data for certain types of object surface topologies. The connectivity errors typically occur for surface regions with high local curvature or with fine detail, where surface inclusions, bumps, spikes, or holes may be flattened or incorrectly filled. The connectivity errors also occur between surfaces of different objects. For objects near each other, edge connections may be formed which erroneously connect the objects.

One typical modeling approach couples a range-finding sensor with an imaging camera. For each view of an object to be modeled, a dense array of depth data is acquired along with an image of the object. Since depth data comes from the range-finding sensor, no feature tracking is performed. Depth data from multiple views is aligned in 3D by a largely manual process in which, for each pair of views to be aligned, the human system operator manually selects a set of three to five depth sample points common to the two views. This approach, see, e.g. U.S. Pat. No. 5,988,862, which aligns depth data sets from different views is quite sensitive to which alignment points are selected and is generally prone to substantial alignment error for depth data not near the chosen alignment points.

Another alignment approach requires that the range-finding sensor move along a prescribed path. Since the sensor position is known for each view, the depth data from different views can be projected into a single world coordinate system. Such systems show reduced alignment error of the depth data between views. However, because of the fixed track along which the sensor moves and the heavy mechanical machinery required for precise sensor positioning, such systems are optimized to model objects of a certain size and cannot adequately model objects of a vastly different size. For example, a system optimized to model a human body would perform poorly on a small vase. This approach is also unsuitable for scene modeling.

A third alignment approach requires placement of a calibration grid in the scene along with the object to be modeled. The position of the range-finding sensor at each view can be determined using the calibration grid, as described, for example, in U.S. Pat. No. 5,886,702. For cases where the calibration grid sufficiently spans the region of space near the object to be modeled, alignment of depth data from multiple views can be precise. However, for many types of objects and for most scenes, placement of a calibration grid in the sensor view is impractical, either because the object occludes too much of the calibration grid, or because the calibration grid occludes portions of the scene and thus impedes texturing the reconstructed scene model.

In range-finding approaches, connectivity of the 3D points is determined from individual views of the object. The range-finding sensor acquires depth data using a two dimensional (2D) grid sampling array. The 2D grid connections determine the eventual connectivity of 3D points. This method of determining mesh edges is fast and provides connectivity that looks correct from the stand point of the original individual views. However, this approach provides no mechanism to detect or arbitrate between conflicting edge connections generated from separate views. Thus, as described in U.S. Pat. No. 6,187,392, the combination of the mesh edge data from separate views into a single model becomes a process of zippering surface patches together, with specification of the exact zippering boundaries requiring extensive operator intervention. For example, if the modeled object is a coffee mug, some views will not show the hole between the cup and the handle. Meshes for those views will connect the handle completely to the cup, erroneously filling in the hole. The system operator must manually find a view that shows the hole and create mesh zippering boundaries that properly join a view that sees the hole with a view that sees the outside of the mug handle. The amount of manual operator work required to combine surface patches would become extremely laborious for scenes or objects with complex surfaces or with nontrivial arrangements of surfaces.

The general approach of surface construction by zippering of surface patch meshes can also be applied to image data. One system uses the 2D pixel grid, from camera images of an object, to determine 3D mesh connectivity, then requires zippering of meshes from individual views in 3D to form a complete model. That approach is subject to the limitations described in the preceding paragraph.

A current area of research in computational geometry focuses on methods for creating 3D surface models given a set of 3D points. Algorithms provide plausible surface models from a variety of 3D point sets. However, none of these methods uses 2D visibility information to guide connectivity of the 3D points. Thus, these modeling approaches tend to incorrectly reconstruct connecting edges when given 3D point data for certain types of object surface topologies. The connectivity errors typically occur for surface regions with high local curvature or fine detail, where surface inclusions, bumps, spikes, or holes may be flattened or incorrectly filled. The connectivity errors also occur between surfaces of different objects. For objects near each other, edge connections may be formed which erroneously connect the objects.

### SUMMARY OF THE INVENTION

The present invention overcomes the problems of the aforementioned prior art systems. In particular, by using visibility information to guide both the alignment of 3D feature points and the connections of the 3D points, this invention provides a method for robust positioning of 3D points and for generating a set of mesh edges that is more visually consistent with the original images.

In an aspect of the invention, a method is implemented for selecting nearest neighbor edges to construct a 3D model from a sequence of 2D images of a scene. The method includes tracking a set of features of the scene among successive images to establish correspondence between the 2D coordinate positions of the 3D feature as viewed in each image.

The method also generates depth data of the feature of the scene, with entries in the data corresponding to the coordinate position of the feature along a depth axis for each image, with depth measured as a distance from a camera image plane for that image view.

The method then uses visibility information extracted from the feature track data, original images, depth data, and input edge data to determine the location of vertices of the 3D model surface. The visibility information also guides the connections of the model vertices to construct the edges of the 3D model.

Embodiments of this aspect can include one or more of the following features. Imaged 3D feature points are tracked to determine 2D feature points to generate a 2D feature track. The depth data and the 2D feature points are projected into a common 3D world coordinate system to generate a point cloud. Each entity of the point cloud corresponds to the projected 2D feature point from a respective image. The point cloud is consolidated into one or more vertices, each vertex representing a robust centroid of a portion of the point cloud. Or the point cloud is consolidated into one or vertices, each vertex being located with a convex hull of the point cloud and satisfying visibility criteria for each image in which the corresponding true 3D feature is visible. In the visibility test, a set of point clouds is projected into a multitude of shared views. A shared view is an original image view that contributes 2D feature points to each point cloud in the set. The vertices derived from each point cloud in the set are also projected into the common views. The visibility criterion requires that the 2D arrangement of the projected vertices, in each common view, be consistent with the 2D arrangement of the contributing 2D feature points from that view.

A nearest neighbors list is built which specifies a set of candidate connections for each vertex. The nearest neighbors are the other vertices that are visibly near the vertex of interest. The near neighbors list for a given vertex may be further limited to vertices that are close, in 3D, to the central vertex. The set of near neighbors lists for multiple vertices are pruned such that the resulting lists contain only vertex connections that satisfy visibility criteria.

Candidate edges for the model are tested for visibility against trusted edge data. The trusted edges can be 2D or 3D and can come from depth edge data, silhouette edge data, or 3D edge data, either as input to the system or as computed from the feature tracks, camera path, and depth data. For each pairing of candidate edge and trusted edge, the candidate edge is projected into each camera view in which the trusted edge is known to be visible. If the candidate edge occludes the trusted edge in any such view, the edge is discarded and the corresponding nearest neighbor vertex is removed from the nearest neighbor list of V.

For each candidate surface face, where the face is a polygon of surface patch bounded by three candidate model edges chosen from a set of near neighbor lists, if the face is determined to be completely visible in any original view, no candidate edge can occlude the view of the face in that view. Any such occluding edge is pruned from the near neighbor lists.

In other embodiments, the 2D feature points and the depth data are projected using camera path data. Each entry of the depth data can be the distance from a corresponding 3D feature point to a camera image plane for a given camera view of the 3D feature point. The depth data is provided as input data or as intermediate data. Since the associated images have trackable features, the depth data can be obtained by other ways. For example, the depth data can be obtained from a laser sensing system. Alternatively, the depth data is obtained from a sonar based system or an IR-based sensing system.

In some other embodiments, the 2D feature tracking data is provided as input data. All or a portion of the model vertices may also be supplied as input data.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of an image processing system which develops a 3D model according to the invention.

FIG. 2 is a more detailed view of a sequence of images and a feature point generation process showing their interaction with a feature tracking, scene modeling, and camera modeling process.

FIG. 3 is a view of a camera path and scene model parameter derivation from feature point tracks.

FIG. 4a is a diagram illustrating the details of an image sequence of a rotating cube.

FIG. 4b is a diagram of one particular point cloud from a feature point of the rotating cube image of FIG. 4a.

FIG. 5 is a flow diagram of a sequence of steps performed by the image processing system of FIG. 1.

FIG. 6 is a more detailed flow diagram of the steps performed to create a 3D vertex.

FIG. 7a is a more detailed flow diagram of the steps performed by the image processing system of FIG. 1 to create a nearest neighbors list for each feature of FIG. 4a.

FIG. 7b is a diagram illustrating the feature point of FIG. 4A projected in 2D along with candidate nearest neighbors.

FIG. 8 is a diagram illustrating the calculation of normals for each vertex created in the process illustrated in FIG. 6.

FIG. 9 is a more detailed flow diagram of the steps performed to create a radially ordered list of nearest neighbors for each vertex created in the process illustrated in FIG. 6.

FIG. 10a is a more detailed flow diagram of the steps performed to prune the radially ordered list of nearest neighbors for each vertex created in the process illustrated in FIG. 6.

FIGS. 10b-10d graphically illustrate the steps of pruning the radially ordered list of near neighbors for each vertex created in the process illustrated in FIG. 6.

FIG. 11 is a more detailed flow diagram performed to seed the surfaces about each vertex created in the process illustrated in FIG. 6.

FIG. 12 is a more detailed flow diagram of a sequence of steps performed to construct a surface of a 3D model scene.

FIG. 13 graphically illustrates a surface crawl step of the sequence of steps of FIG. 5.

FIG. 14 graphically illustrates a hole filling step of the sequence of steps of FIG. 5.

### DETAILED DESCRIPTION OF THE INVENTION

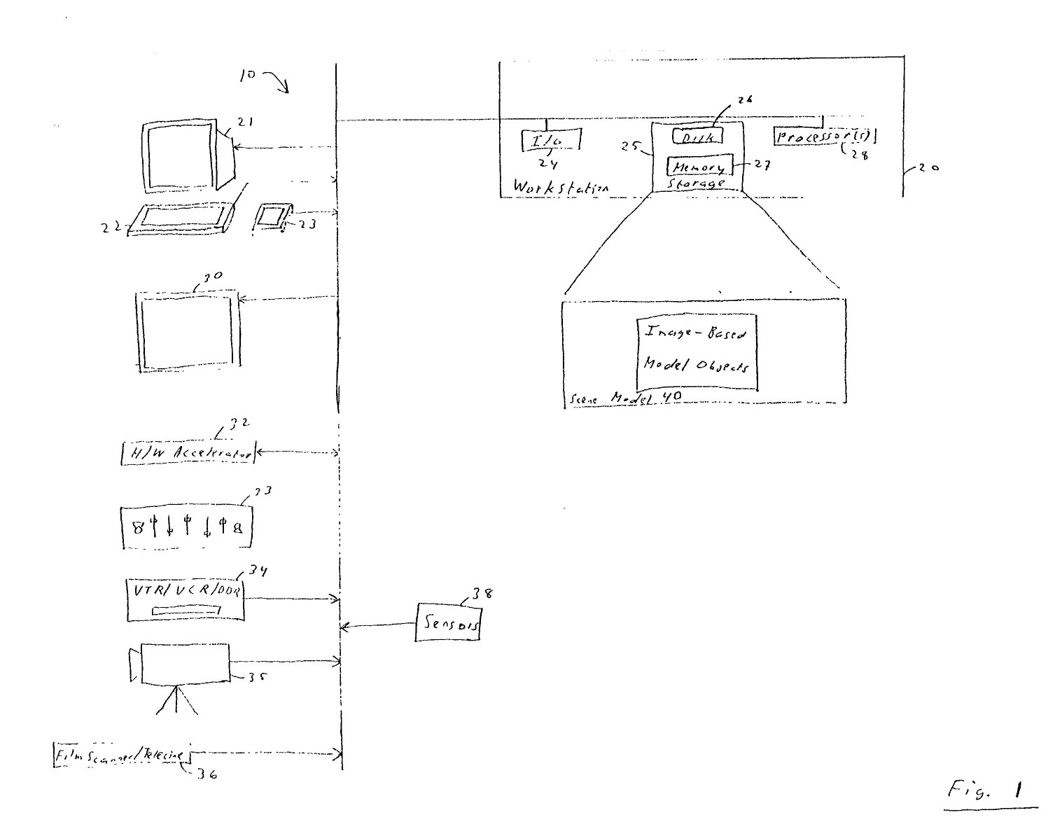

A description of preferred embodiments of the invention follows. Turning attention now in particular to the drawings, FIG. 1 is a block diagram of the components of a digital image processing system 10 according to the invention. The system 10 includes a computer workstation 20, a computer monitor 21, and input devices such as a keyboard 22 and mouse 23. The workstation 20 also includes input/output interfaces 24, storage 25, such as a disk 26 and random access memory 27, as well as one or more processors 28. The workstation 20 may be a computer graphics workstation such as the 02/Octane sold by Silicon Graphics, Inc., a Windows NT type-work station, or other suitable computer or computers. The computer monitor 21, keyboard 22, mouse 23, and other input devices are used to interact with various software elements of the system existing in the workstation 20 to cause programs to be run and data to be stored as described below.

The system 10 also includes a number of other hardware elements typical of an image processing system, such as a video monitor 30, hardware accelerator 32, and user input devices 33. Also included are image capture devices, such as a video cassette recorder (VCR), video tape recorder (VTR), and/or digital disk recorder 34 (DDR), cameras 35, and/or film scanner/telecine 36. Sensors 38 may also provide information about the scene and image capture devices.

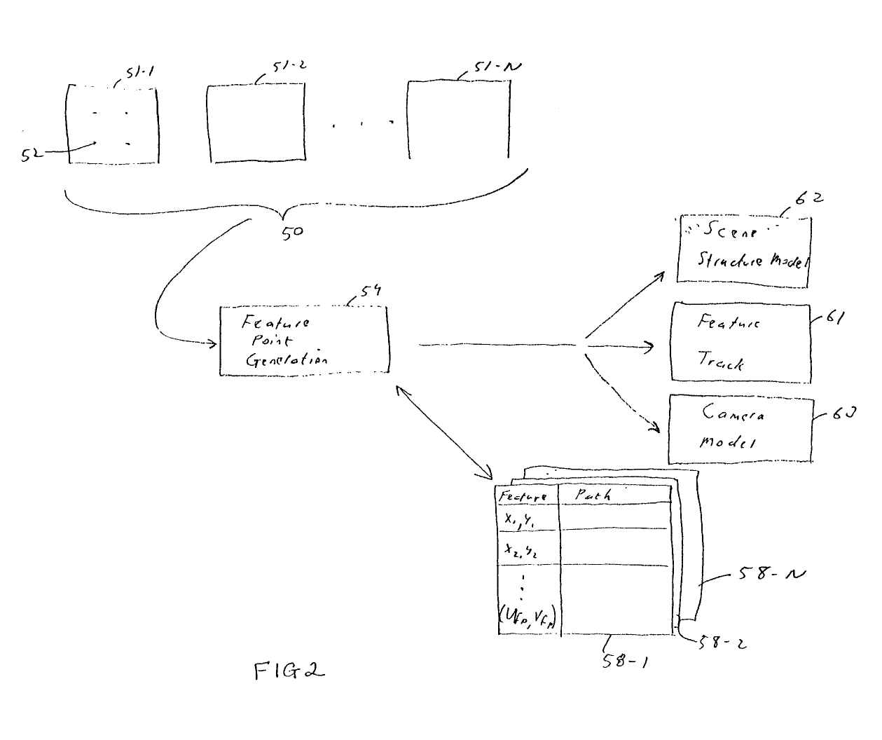

The present invention is concerned with a technique for generating an array of connected feature points from a sequence of images provided by one of the image capture devices to produce a 3D scene model 40. The scene model 40 is a 3D model of an environment or set of objects, for example, a model of the interior of a room, a cityscape, or a landscape. The 3D model is formed from a set of vertices in 3D, a set of edges that connect the vertices, and a set of polygonal faces or surface patches that compose a surface that spans the edges. As shown in FIG. 2, a sequence 50 of images 51-1, 51-2, . . . , 51-N are provided to a feature point generation process 54. An output of the feature point generation process 54 is a set of arrays 58-1, 58-2, . . . , 58-F of 2D feature points with typically an array 58 for each input image 51. For example, the images 51 may be provided at a resolution of 720 by 486 pixels. Each entry in a 2D feature array 58, however, may actually represent a feature selected within a region of the image 51, such as over a M×M-pixel tile. That is, the tile is a set of pixels that correspond to a given feature, as the feature is viewed in a single image. The invention is concerned, in particular, with the tracking of features on an object (or in a scene) over the sequence 50 and constructing a 3D scene model or object model from the images 51-1, 51-2, . . . , 51-N, the object model being a 3D model of a single object or small set of objects. Essentially, an object model is a special case of a scene model.

As a result of the process of executing 2D feature point generation 54 and a feature track process 61, a per-frame depth computation process 62, camera modeling process 63, or other image processing techniques may be applied more readily than in the past.

Feature tracking 61 may, for example, estimate the path or “directional flow” of two-dimensional shapes across the sequence of image frames 50, or estimate three-dimensional paths of selected feature points. The camera modeling processes 63 may estimate the camera paths in three dimensions from multiple feature points.

Considering the scene structure modeling 62 more particularly, the sequence 50 of images 51-1, and 51-2, . . . , 51-N is taken from a camera that is moving relative to an object. Imagine that we locate P 2D feature points 52 in the first image 51-1. Each 2D feature point 52 corresponds to a single world point, located at position sₚ in some fixed world coordinate system. This point will appear at varying positions in each of the following images 51-2, . . . , 51-N, depending on the position and orientation of the camera in that image. The observed image position of point p in frame f is written as the two-vector u_{fp} containing its image x- and y- coordinates, which is sometimes written as (u_{fp},v_{fp}). These image positions are measured by tracking the feature from frame to frame using known feature tracking 61 techniques.

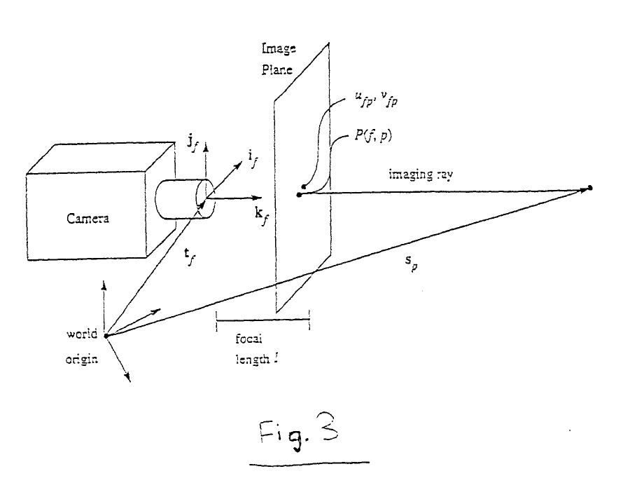

The camera position and orientation in each frame is described by a rotation matrix R_{f} and a translation vector t_{f} representing the transformation from world coordinates to camera coordinates in each frame. It is possible to physically interpret the rows of R_{f} as giving the orientation of the camera axes in each frame—the first row i_{f}, gives the orientation of the camera's x-axis, the second row, j_{f}, gives the orientation of the camera's y-axis, and the third row, k_{f}, gives the orientation of the camera's optical axis, which points along the camera's line of sight. The vector t_{f} indicates the position of the camera in each frame by pointing from the world origin to the camera's focal point. This formulation is illustrated in FIG. 3.

The process of projecting a three-dimensional point onto the image plane in a given frame is referred to as projection. This process models the physical process by which light from a point in the world is focused on the camera's image plane, and mathematical projection models of various degrees of sophistication can be used to compute the expected or predicted image positions P(f,p) as a function of sₚ, R_{f}, and t_{f}. In fact, this process depends not only on the position of a point and the position and orientation of the camera, but also on the complex lens optics and image digitization characteristics.

The specific algorithms used to derive per-frame depth data 62 or a camera model 63 are not of particular importance to the present invention. Rather, the present invention is concerned with a technique for efficiently developing the meshes of connected vertices that underlie the surfaces of a 3D scene model, where the meshes and model are derived from a sequence of 2D images.

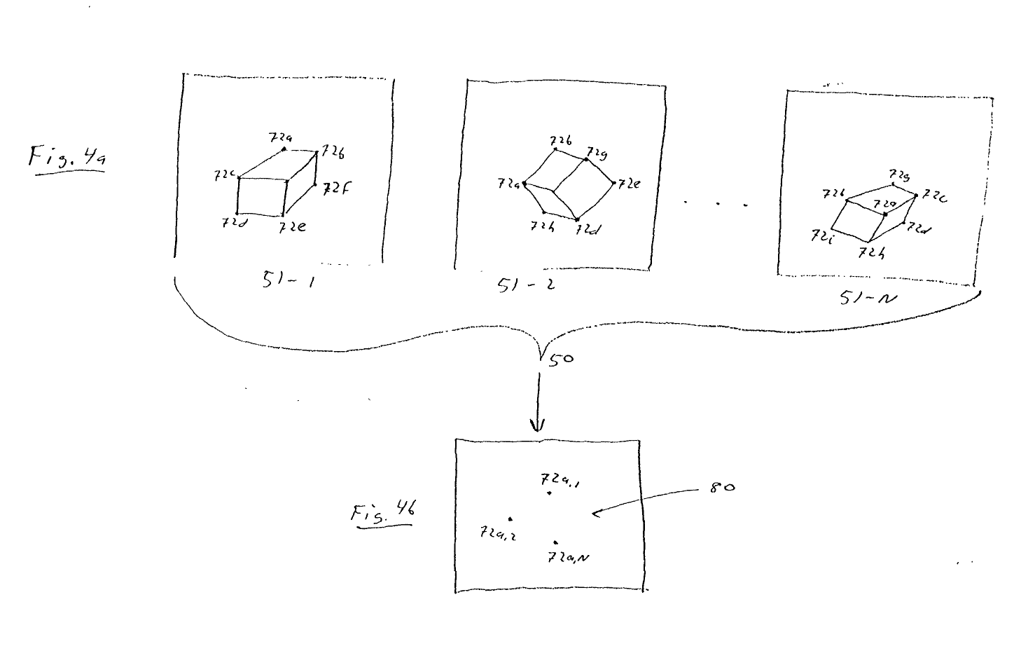

Consider for example, as shown in FIG. 4a, an image stream or sequence 50 which contains images of a rotating cube 70. The visual corners, collectively referred to as corners or feature points 72, of the cube 70 are what is traditionally detected and tracked in feature tracking algorithms. The position for each feature point 72 in frame 1 is stored as a 2D (x₁,y₁) position.

As the image stream progresses, a subsequent image 51-2 results in the generation of the next position (x₂,y₂) of the feature point, and image 51-N results in the position (x_{N},y_{N}). Combining 2D feature track data with depth data yields the 3D position data (x₁,y₁,z₁) across the sequence 50, where i=1, 2, . . . , and N refers to the corresponding frame number. Thus, a “feature track” is the location (x₁,y₁,z₁) of the feature point 72, for example, in a sequence of frames. Thus, a “true 3D” feature point is a feature point in the real-world scene or object to be modeled. The depth is the recovered distance from a given true 3D feature point to the camera image plane, for a given camera view of the 3D feature point, so that a depth array is an array of depth values for a set of 3D feature points computed with respect to a given camera location. The depth data is provided as an initial input or as intermediate data. Further, the depth data may be obtained from laser, sonar, or IR-based sensing systems.

As the image sequence progresses, the feature point therefore translates across successive images 51-2, . . . , 51-N. Eventually, some feature points 72 will be lost between images due to imaging artifacts, noise, occlusions, or similar factors. For example, by the time image 51-N is reached, the cube 70 may have rotated just about out of view. As such, these feature points 72 are tracked until they are lost.

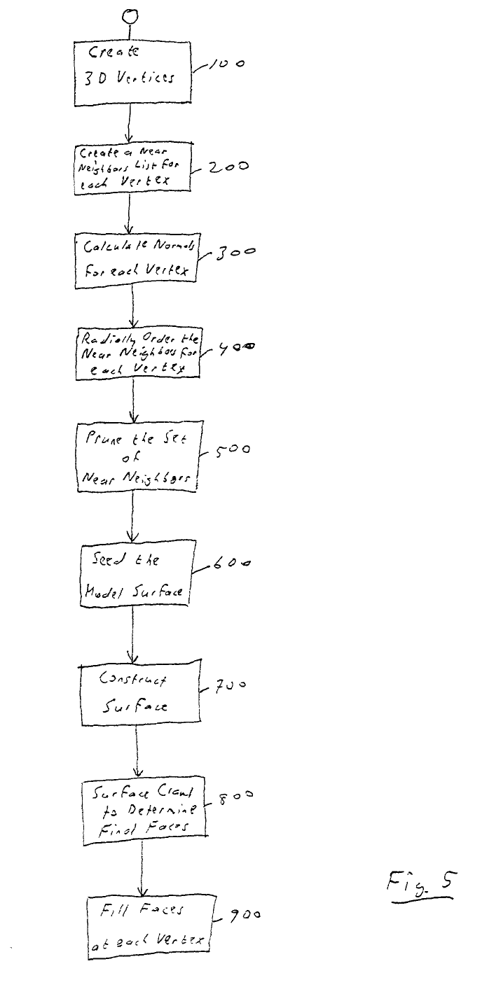

One implementation of the 3D scene model surface construction for the image sequence 50 of FIG. 4a is illustrated in FIG. 5.

Referring also to FIG. 6, for each 2D feature track, in a first state 100, a 3D model vertex is created for each feature point, for example feature point 72a shown in FIG. 4a. All of the feature points are tracked across images 51-1, 51-2, . . . , 51-N to generate feature track data 102. Also, camera path data 104 is extracted for the sequence 50. The 2D feature track data 102 is combined with camera path data 104 and depth data 106 so that in a state 108 the tracked location from each view is projected into three dimensions, that is, the coordinate (x₁,y₁,z₁) is obtained for each frame i for a particular feature point. Next, in a state 110, a point cloud is generated from the projected 3D points. For example, referring to FIG. 4b, a point cloud 80 is generated by tracking a feature point 72a across the sequence 50. (Note that FIG. 4b, only shows the position of point 72a from images 51-1, 51-2, and 51-N, that is, only three entities, 72^{a,1}, 72_{a,2}, and 72_{a,N}, of the point cloud 80 are shown.) In sum, the point cloud is a set of projected 2D feature points corresponding to a single 3D feature point, with the 2D feature points projected into a common world coordinate system.

Next, in a next state 112, the point cloud 80 is consolidated into a vertex, “V,” which is computed from the entities of the point cloud 80. For example, the vertex could be computed as a robust centroid of the point cloud data. Typically, a single vertex will best fit the data. If, however, the original 2D track had tracked a feature that spanned both the foreground and background, then a pair of vertices may best represent the point cloud data. If the tracking data represents a point moving along an object's silhouette, then a set of vertices may best represent the point cloud. The vertex V is a recovered 3D feature point, that is, a 3D point on the model surface. The location of the vertex V in 3D represents the best estimate of the location of a true 3D feature point, with the location estimated from the corresponding point cloud. A set of vertex position data may also be accepted as input to the system.

Each vertex derived from the point cloud data must be located within the convex hull of the point cloud and satisfy visibility criteria for each image in which the corresponding true 3D feature is visible. In the visibility test, a set of point clouds is projected into a multitude of shared views. A shared view is an original image view that contributes 2D feature points to each point cloud in the set. The vertices derived from each point cloud in the set are also projected into the common views. The visibility criterion requires that the 2D arrangement of the projected vertices, in each common view, be consistent with the 2D arrangement of the contributing 2D feature points from that view.

Referring again to FIG. 5, in a state 200 a near neighbors list is generated for each vertex that has been created for its respective feature point 72. The near neighbors are the other vertices for their respective feature points that are visibly near the vertex, “V.” This list specifies a set of candidate connections for each vertex, that is, a potential edge that can be drawn from V to the nearest neighbor.

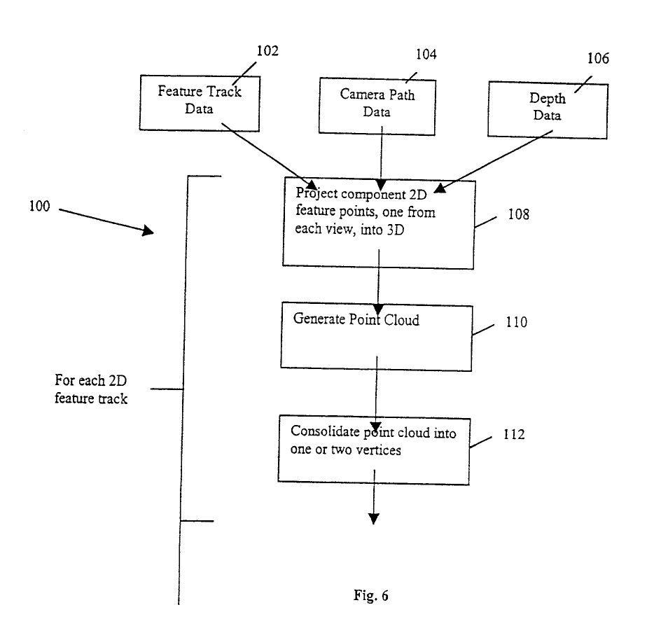

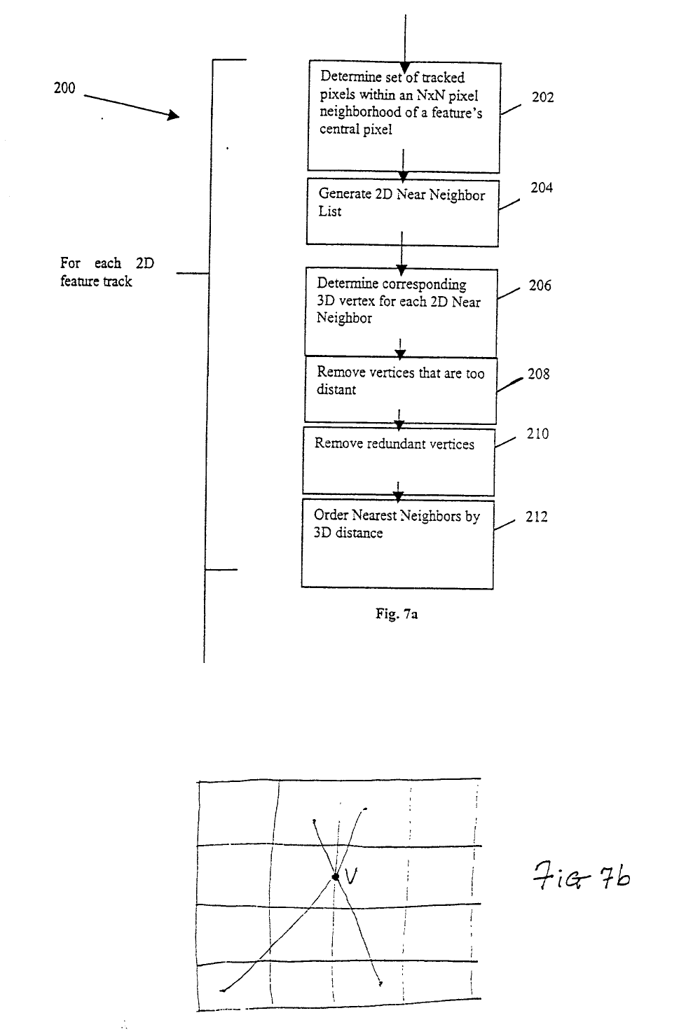

Referring to FIG. 7a, state 200 is described in more detail. For each 2D feature track, in a state 202, the set of tracked pixels within an N×N pixel neighborhood (FIG. 7b) of a feature point's central pixel is determined. Next, in a state 204, a 2D nearest neighbor list is generated. Then, in a state 206, for each 2D nearest neighbor a corresponding 3D vertex is determined. State 206 is followed by a state 208 in which the nearest neighbors vertices that are too distant (in 3D) from the vertex, “V,” are removed. Next, in a state 210, redundant nearest neighbor vertices are removed from the list. Thus, the list generated in a state 212, is ordered by the 3D distance from the vertex, “V.”

After the nearest neighbors list is generated for each vertex in the state 200, the normals for each vertex are calculated in a state 300, as illustrated in FIG. 8. In this step, V and all its nearest neighbors, “nn,” are projected onto a 2D plane 302. If at least two of these projected nearest neighbors exist, these nearest neighbors and V are connected to form a triangle 304. For each triangle 304, the cross product is used to calculate a normal vector, for example, normal vectors 306a, 306b, 306c, and 306d. These normals are robustly averaged to determine a normal for V.

Alternatively, for each vertex, “V,” a plane is fitted to the entire list of nearest neighbors of V and a normal for that plane is calculated. If the normals computed from the above two approaches agree sufficiently, the normal from the second method is used. Otherwise, the operation is flagged for further processing. In such a case, the normal calculated from the first method is used.

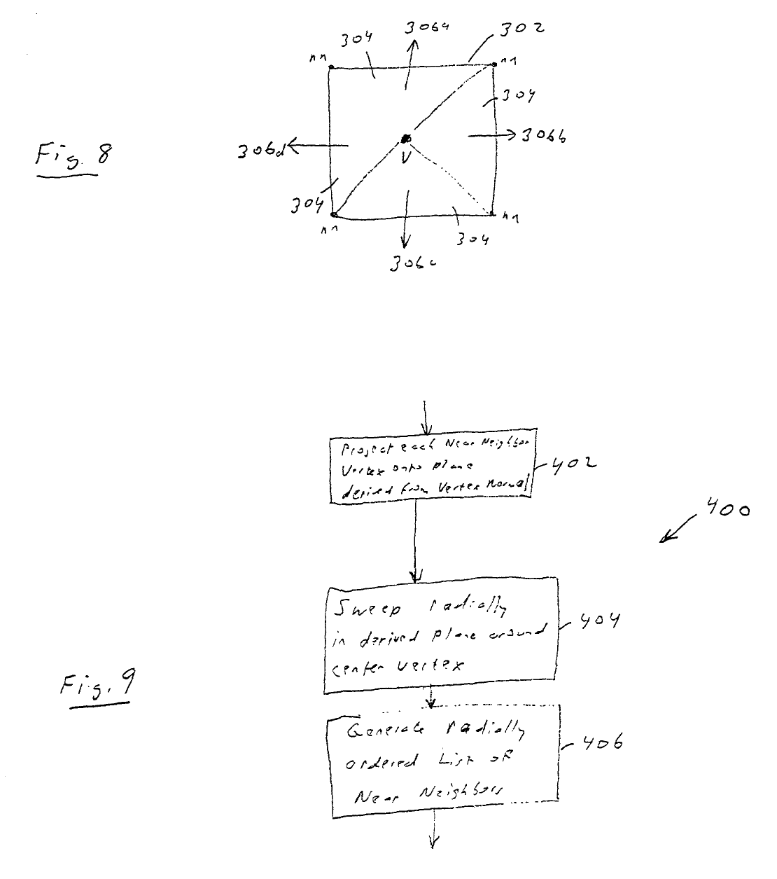

Next, referring again to FIG. 5 and also to FIG. 9, in a state 400, the nearest neighbors for each vertex (referred to now as the center vertex) are radially ordered. In more detail, in a state 402 the vertex for each nearest neighbor is projected onto the plane having a normal derived in state 300. Then by sweeping radially in this plane, as in a step 404, a radially ordered list of nearest neighbors is generated, as in a step 406.

The candidate edges that connect each vertex to its nearest neighbors are then tested for visibility against trusted edge data. The trusted edges can be 2D or 3D and can come from depth edge data, silhouette edge data, or 3D edge data, either as input to the system or as computed from the feature tracks, camera path, and depth data. For each pairing of candidate edge and trusted edge, the candidate edge is projected into each camera view in which the trusted edge is known to be visible. If the candidate edge occludes the trusted edge in any such view, the edge is discarded and the corresponding nearest neighbor vertex is removed from the nearest neighbor list of V.

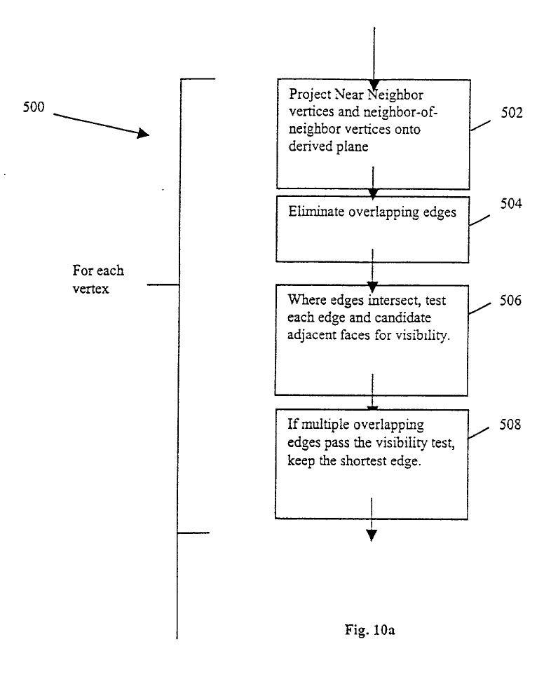

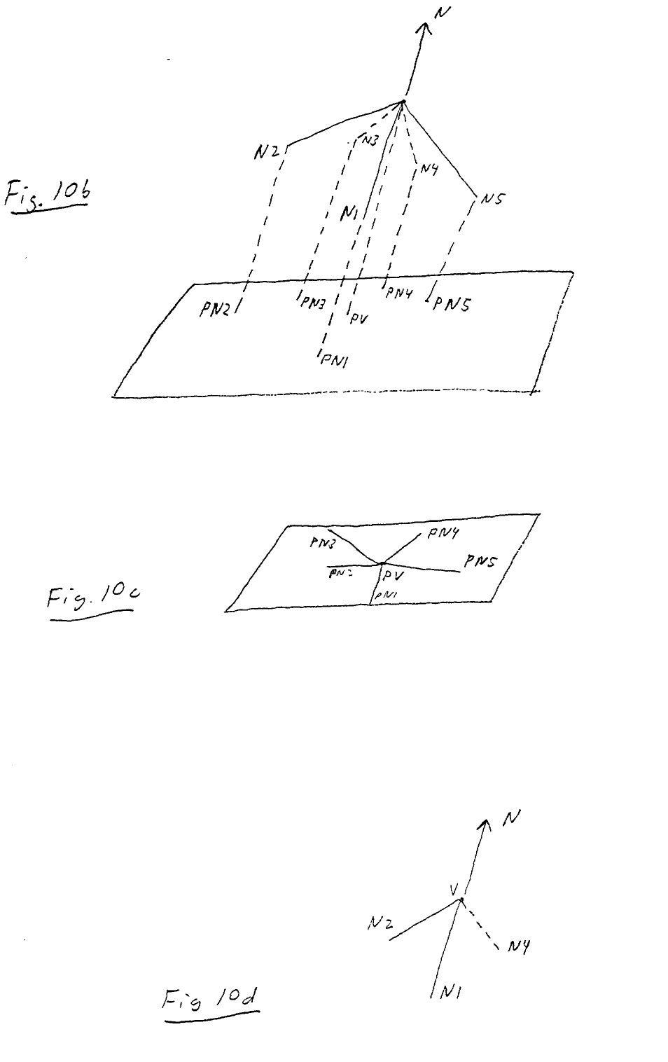

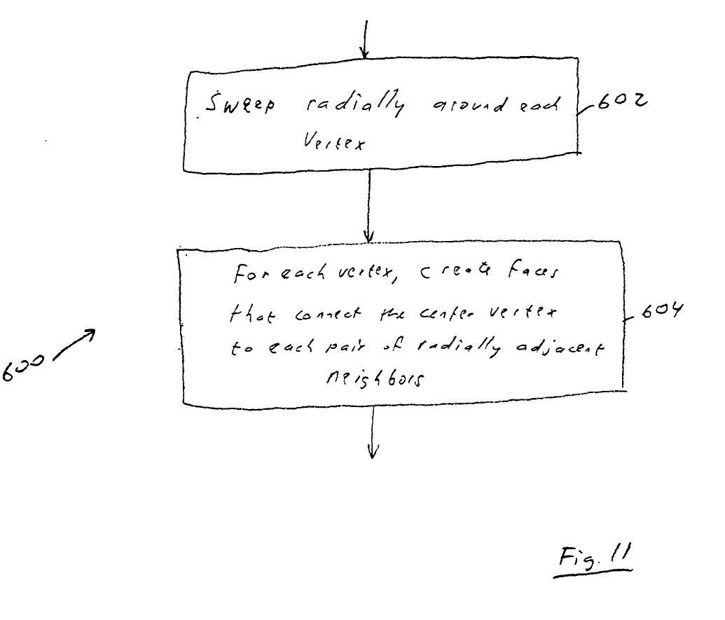

Next, in a state 500, the set of radially ordered nearest neighbors is pruned by the process described in detail in FIG. 10a. For each V, in a state 502, the vertices for the nearest neighbor, as well as the vertices of the neighbors of the nearest neighbors are projected onto the normal plane derived in the process discussed above, and edges are drawn from V to the nearest neighbors. A larger web of near neighbors vertices can also be used. For example, extending to vertices that are neighbors of neighbors of neighbors of a central vertex. Then, in a state 504, overlapping edges are eliminated. For example, by starting with the two projected nearest neighbor vertices that are closest to V, the angle formed between the respective edges is determined. If these two edges form an angle that is less than R_{NN} degrees, any neighbors whose projected points are inside that angle are removed. Next, in a state 506, for edges that intersect, each edge and candidate adjacent faces are tested for visibility. In a state 508, if multiple overlapping edges pass the visibility test, the shortest edge is kept. Of the remaining edges, the next closest neighbor to V is found, and the process is repeated.

An example of the pruning algorithm is illustrated in FIGS. 10b-10d. The process begins with vertex V, its neighbors N1-N5, and normal N as known. Assume the neighbors, N1 through N5, when sorted by the 3D distance from V are N4, N2, N3, N1, and N5. The pruning algorithm selects the projected neighbors PN2 and PN4 for the first examination. Next, the projected neighbors PN1, PN3, and PN5 are considered. Thus in the first step, N3 gets removed since PN3 is radially between PN2 and PN4. Next, N1 is chosen, and N5 is removed since it is radially between N1 and N4. After the pruning process, the remaining points appear as in FIG. 10d.

Following the pruning process, in a state 600, seed faces are created. In a state 602 (FIG. 11), each vertex V is swept around radially. Then, in a state 604, each V is connected to each pair of radially adjacent neighbors, thereby creating a set of triangular shaped seed surface faces.

As the seed faces are created in state 600, a visibility test is applied to ensure that the seed faces do not erroneously occlude any trusted edges. The trusted edges can be 2D or 3D and can come from depth edge data, silhouette edge data, or 3D edge data, either as input to the system or as computed from the feature tracks, camera path, and depth data. For each pairing of candidate face and trusted edge, the candidate face is projected into each camera view in which the trusted edge is known to be visible. If the candidate face occludes the trusted edge in any such view, the face is discarded.

Further visibility tests are applied to ensure that the seed faces do not erroneously occlude any vertices or other seed faces. For each pairing of candidate face and model vertex, the candidate face is projected into each camera view in which the vertex is known to be visible. If the candidate face occludes the vertex in any such view, the candidate face is rejected. For each pairing of candidate face and existing seed face, the candidate face is projected into each camera view in which the existing face has been determined to be completely visible. If the candidate face occludes the existing face in any such view, the candidate face is rejected. Additionally, if the existing face occludes the candidate face in any view in which the candidate face has been determined to be completely visible, the existing face is removed. For cases where the existing face is determined to be partially visible, the image texture corresponding to the existing face is compared across views in which the existing face is visible; the occluding edges of the candidate face are then projected into each of those views; if the 2D motion of the projected occluding edges is inconsistent with the change in texture of the existing face throughout the views, then the candidate face is rejected. The existing face is similarly tested against the candidate face. If the candidate face passes the above visibility tests, it becomes a seed face and part of the model surface.

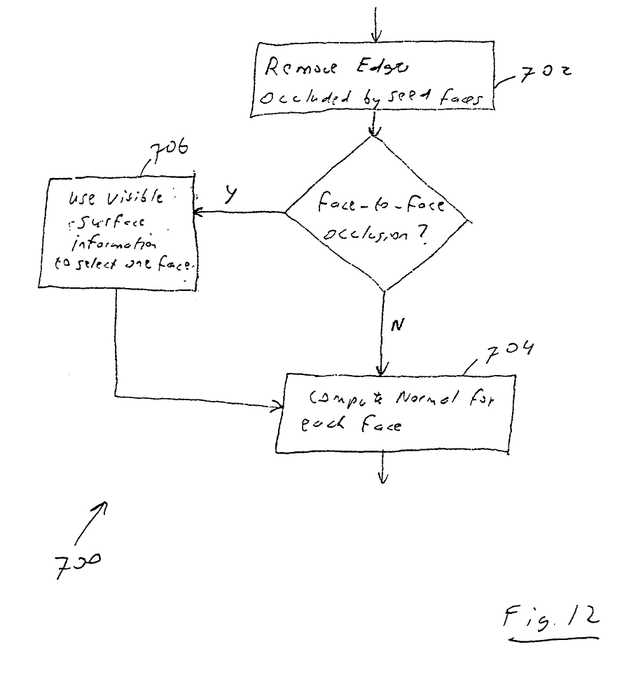

Referring to FIG. 12, after the seed faces have been generated, the construction of the other surfaces is initiated in a state 700. First, in a state 702, edges occluded by seed faces are removed. If, in a state 704, there is no face to face occlusion, the normal for each face is calculated. Otherwise, in a state 706, visible surface information is used to either (a) select one face before computing the normal or (b) allow both faces to contribute to the normal. The visibility test are the same as those used to arbitrate between occluding faces during creation of seed faces (state 600).

In a state 800, a crawling algorithm is used which crawls from a starting vertex to its nearest neighbors and then to their neighbors. If the crawling process does not touch each vertex, then a new untouched starter vertex is chosen. The process is repeated until all the vertices have been processed.

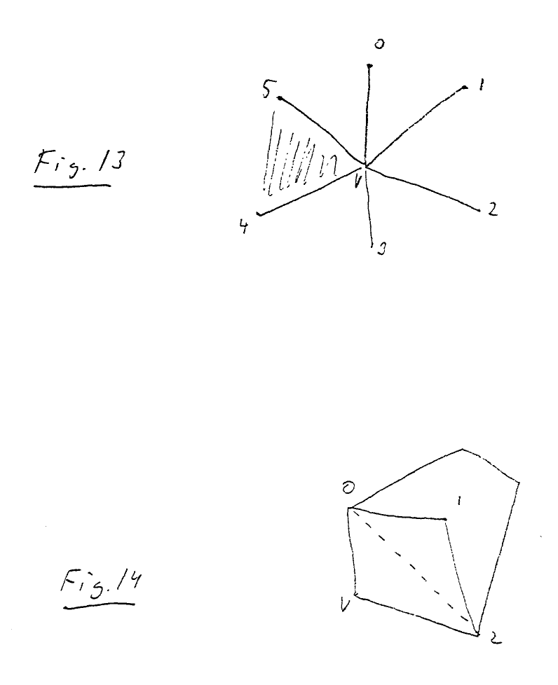

During the crawling process, in a state 900, the faces for each vertex are filled, as illustrated in FIG. 13. For example, if the span 4, 5 is already filled upon reaching V, then the two regions: 0,4 and 0,5 are marked as filled. Then the other edges are examined, for instance, the three edges V,0; V,1; and V,2. If the included face normals calculated in step 700 are sufficiently close and the angle for the span 0,2 is less than R_{SC} degrees, then edge V,1 is removed, and face 0,1,2,V is created (FIG. 14). If the normals differ sufficiently, then edge V,1 is kept, and a new edge 0,1 is created. The process is then repeated, for example, for the next three consecutive edges V,0; V,2; and V,3, until all the regions for V have been processed. Each face created during the crawling process must pass the visibility tests described above for the seed face creation process.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for nearest neighbor edge selection to construct a 3D model from a sequence of 2D images of an object or scene, comprising the steps of:
providing a set of images from different views of the object or scene;
tracking features of the scene among successive images to establish correspondence between the 2D coordinate positions of a true 3D features as viewed in each image;
generating depth data of the features of the scene from each image of the sequence, with entries in the data corresponding to the coordinate position of the feature along a depth axis for each image, with depth measured as a distance from a camera image plane for that image view;
aligning the depth data in 3D to form vertices of the model;
connecting the vertices to form the edges of the model; and
using visibility information from feature track data, original images, depth data and input edge data to arbitrate among multiple geometrically feasible vertex connections to construct surface detail of the 3D model.

2. The method of claim 1, wherein the step of tracking includes identifying 2D feature points from the images of true 3D feature points, and establishing correspondence of the 2D feature points among a set of images, to generate a 2D feature track.

3. The method of claim 2, further comprising projecting the depth data and the 2D feature points into a common 3D world coordinate system.

4. The method of claim 3, further comprising generating a point cloud for each feature point from the 3D projection, with each entity of the point cloud corresponding to the projected 2D feature point from a respective image.

5. The method of claim 4, wherein the step of using includes consolidating the point cloud into one or more vertices, each vertex representing a robust centroid of a portion of the point cloud.

6. The method of claim 5, further comprising building a nearest neighbors list that specifies a set of candidate connections for each vertex, the nearest neighbors being other vertices that are visibly near the central vertex.

7. The method of claim 6, further limiting the near neighbors list to vertices that are close, in 3D, to the central vertex.

8. The method of claim 6, further comprising pruning a set of near neighbors lists for multiple vertices such that resulting lists correspond to vertex connections that satisfy visibility criteria.

9. The method of claim 8, wherein the candidate edges and faces for the model are tested for visibility against trusted edge data.

10. The method of claim 9, wherein the candidate edges and faces for the model are tested for visibility against trusted edge data derived from silhouette edge data.

11. The method of claim 9, wherein the candidate edges and faces for the model are tested for visibility against trusted edge data derived from 3D edge data.

12. The method of claim 9, wherein the candidate edges and faces for the model are tested for visibility against trusted edge data derived from depth edge data.

13. The method of claim 9, wherein for each candidate surface face, when the face is a polygon or surface patch bounded by three candidate model edges chosen from a set of near neighbor lists, no candidate edge can occlude the view of that face in that view if the face is determined to be completely visible in any original view, and any such occluding edge is pruned from the near neighbor lists.

14. The method of claim 4, wherein the step of using includes consolidating the point cloud into one or more vertices, each vertex being located within a convex hull of the point cloud and satisfying visibility criteria for each image in which the corresponding true 3D feature is visible.

15. The method of claim 4, wherein the step of using includes projecting a set of pint clouds into a multitude of shared views, a shared view being an original image view that contributes 2D feature points to each point cloud in the set, and projecting vertices derived from each point cloud in the set into the shared views, and the step of using requires the 2D arrangement of the projected vertices, in each shared view, being consistent with the 2D arrangement of the contributing 2D feature points from that view.

16. The method of claim 1, wherein each entry of the depth data is the distance from a corresponding 3D feature point to the camera image plane for a given camera view of the true 3D feature point.

17. The method of claim 1, wherein the depth data is provided as input data.

18. The method of claim 1, wherein the depth data is provided as intermediate data.

19. The method of claim 1, wherein the depth data is obtained from a laser sensing system.

20. The method of claim 1, wherein the depth data is obtained from a sonar sensing system.

21. The method of claim 1, wherein the depth data is obtained from an IR-based sensing system.

22. The method of claim 1, wherein the 2D feature tracking data is provided as input data.

23. The method of claim 1, further comprising the step of providing vertex position data as input data.

24. The method of claim 1, further comprising the step of providing depth edge data as input data.

25. The method of claim 1, further comprising the step of providing silhouette edge data as input data.

26. The method of claim 1, further comprising the step of providing 3D edge data as input data.
